(19) United States
(12) Patent Application Publication
(10) Pub. No.: US 2013/0181883 A1
(43) Pub. Date: Jul. 18, 2013

(54) DUAL DISPLAY LAPTOP COMPUTER WITH PROGRAM LOGIC FOR DUAL DISPLAY MODES

(71) Applicant: ROBERTO FRANCO GARCIA, RIO DE JANEIRO (BR)

(72) Inventor: ROBERTO FRANCO GARCIA, RIO DE JANEIRO (BR)

(21) Appl. No.: 13/398,554

(22) Filed: Feb. 16, 2012

(30) Foreign Application Priority Data
Jan. 12, 2012 (CN) 201220011912.5

(51) Int. Cl. G09G 5/00

(52) U.S. Cl. 345/1.1

(57) ABSTRACT

A Dual Display Laptop Computer with Logic for display modes includes a Base, a Dual display assembly, and Program Logic. This Dual Display Laptop Computer with Logic for display modes is used for the purpose of enabling one or more persons to view various multimedia from a laptop operator standing at an opposite side of the laptop relative to the laptop operator.

### FIELD OF THE INVENTION

The present invention is in the area of computer technology and more particularly pertains to a Dual Display Laptop Computer with Logic for display modes for the purpose of enabling one or more persons to view various multimedia on the opposite side as the laptop operator.

### BACKGROUND

As computer technology continues its inexorable move towards smaller form factors, the components thereof have become increasingly stronger, lighter, cheaper, durable, and more versatile. One element in particular is the glass with which multimedia is displayed on most laptop computers.

Today's glass is capable of being scratch resistant, extremely thin, with a high compression strength heretofore unmatched. Yet, the glass is also enabled to be responsive enough to be used as a touch screen interface.

With the recent improvements in glass technology, the fact that most laptops only have one screen which faces the keyboard underscores a significant waste of space for the end user. By placing an anterior screen opposite the posterior screen, more value is derived by increasing the functional usage of the surface area surrounding the laptop computer.

For instance, one use of a dual screen laptop computer would be for retail stores. If the laptop is used as a cash register, the posterior screen can enable the user to register the cost of goods sold, whereas on the opposite side of the laptop, a consumer can view and confirm various information about his or her purchases, as well as the attendant price and tax information.

In other instances, a dual screen laptop can be used as a presentation device for an audience within close range. This advantage would be preferable to using a power point presentation where there may be no large screen and projector available.

Therefore, what is clearly needed in the art is a dual screen laptop computer which is capable of transmitting a plurality of multimedia displays to both sides of a laptop computer for at least one or more persons to view the information at the opposite end of the laptop operator thereby maximizing surface area usage of the laptop computer.

### SUMMARY

In general, in a first aspect, the Dual Display Laptop Computer with Logic for display modes features a Base, a Dual display assembly, and Program Logic. The Dual display assembly comprises an anterior display screen and a posterior display screen.

In one aspect of an embodiment, the anterior display screen may display the same multimedia, indicia, or other signals as the posterior display screen. In other instances, the anterior display screen may display various multimedia which is not simultaneously displayed on the posterior display screen.

In another instance of an embodiment, the anterior display screen may operate in touch screen mode. Alternatively, the motherboard can implement program logic to command the anterior display screen to operate in a fixed mode, or in a presentation mode.

The features and advantages described in this summary and the following detailed description are not all-inclusive. Many additional features and advantages will be apparent to one of ordinary skill in the art in view of the drawings, specification, and claims thereof.

### BRIEF DESCRIPTION OF THE DRAWING FIGURES

FIG. 1 is a perspective view of an embodiment.

FIG. 2 is a perspective view of an embodiment.

FIG. 3 is a side elevation view of an embodiment.

### DETAILED DESCRIPTION

According to an embodiment of the present invention, a unique Dual Display Laptop Computer with Logic for display modes is provided for the purpose of enabling a laptop operator to display various indicia or multimedia on the opposite display screen. The embodiment can be used as a presentation apparatus. The embodiments are described in enabling detail below.

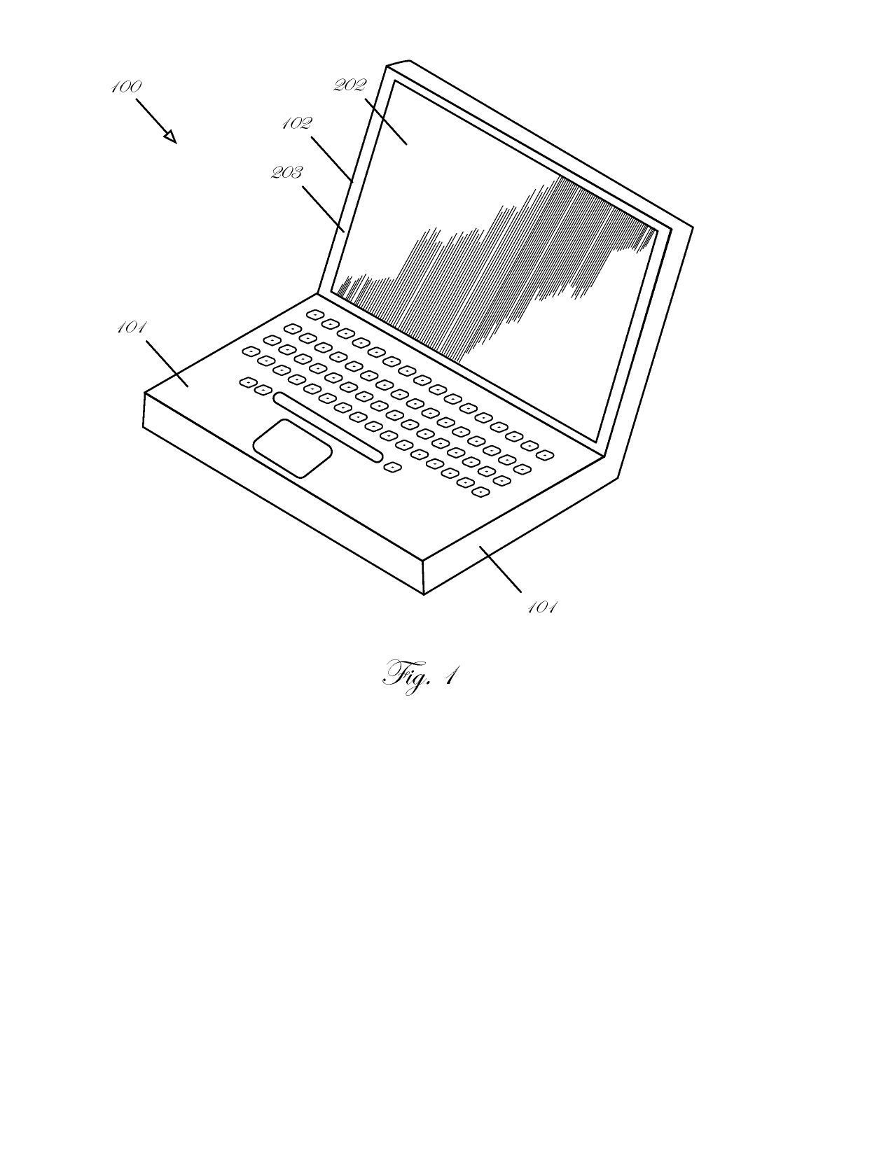

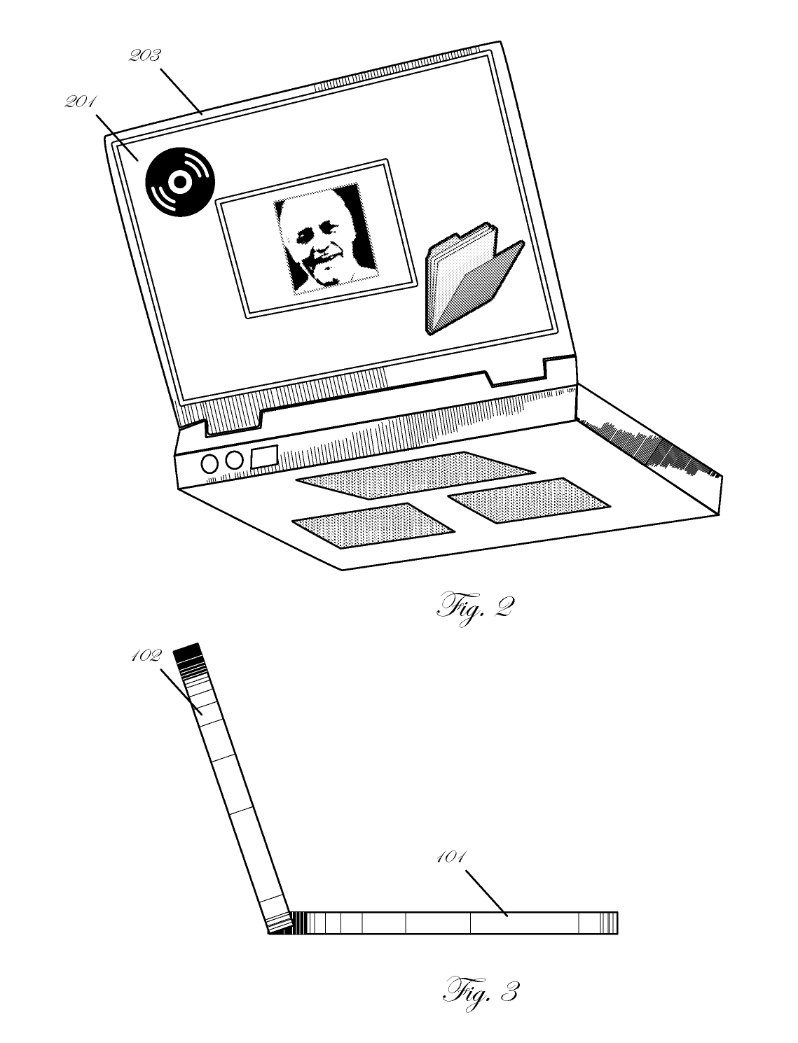

FIG. 1 illustrates that the Dual Display Laptop Computer with Logic for display modes 100 includes a Base 101, a Dual display assembly 102, and Program Logic.

The Base 101 is used for the purpose of housing the Program Logic and controlling the dual display assembly. In one embodiment, the Base 101 has a rectangular shape. The Base is in communication with the dual display assembly. Moreover, in various implementations of an embodiment, the Base can be a typical desktop computer. The Base, in one embodiment includes a First video output 125, a Second video output 135, and a Motherboard 150. The First video output is used for the purpose of transmitting signals between the motherboard and the anterior display screen. The Second video output is used for the purpose of transmitting signals between the motherboard and the posterior display screen. The Motherboard is used for the purpose of transmitting signals and multimedia content through the video outputs to the dual display assembly.

The Dual display assembly 102 is used for the purpose of displaying multimedia content one two separate screens opposing each other to enable two or more persons to view the multimedia from opposite sides of the laptop computer. The Dual display assembly, in one embodiment includes an Anterior display screen 201, a Posterior Display Screen 202, and a Display Frame 203. Also, the Dual display assembly is in communication with the motherboard through the first video output and the second video output.

It should be noted that in one aspect of an embodiment, the Anterior Display Screen might be controlled by program logic in order to minimize energy usage. The Anterior Display Screen may be automatically turned off when not in use. In addition, the Anterior Display Screen may be placed on sleep mode, or similar states of operation.

In one embodiment, the Anterior Display screen may be formed of an alkali-aluminosilicate sheet glass, which is capable of being thin, light, and scratch-resistant. Moreover, this material is expedient for use with touch screens such as smartphones, and in the present embodiment, a touch screen interface.

The Display Frame is used for the purpose of retaining the posterior display screen and the anterior display screen by sandwiching the two screens together such that they are aligned parallel with each other.

The Program Logic is used for the purpose of sending a first transmission signal to the posterior display screen and sending a second transmission signal to the anterior display screen. Also, the Program Logic is in communication between the motherboard and the posterior display screen and the anterior display screen. Moreover, in various implementations of an embodiment, the Program Logic can also send instructions for the anterior display screen to operate in a locked position so that the screen may be fixed and stationary. Whereas in other modes, the anterior display screen may be floating and fluid as per the particular position of the display screen. This position may be detected through use of various accelerometers, or other devices.

It will be apparent to the skilled artisan that there are numerous changes that may be made in embodiments described herein without departing from the spirit and scope of those embodiments. As such, the embodiments taught herein by specific examples are limited only by the scope of the claims that follow.

What is claimed is:

1. A Dual Display Laptop Computer with Logic for display modes comprising:
a Base having a rectangular shape for the purpose of housing the Program Logic and controlling the dual display assembly, a Dual display assembly for the purpose of displaying multimedia content one two separate screens opposing each other to enable two or more persons to view the multimedia from opposite sides of the laptop computer, and a Program Logic for the purpose of sending a first transmission signal to the posterior display screen and sending a second transmission signal to the anterior display screen;
the Base comprises a motherboard, a first video output, a second video output, and a keyboard;
the Base in communication with the dual display assembly;
the Dual display assembly in communication with the motherboard through the first video output and the second video output;
the Program Logic in communication between the motherboard and the posterior display screen and the anterior display screen;
the dual display assembly comprises a posterior display screen, an anterior display screen, and a display frame;
the display frame retains the anterior display screen and the posterior display screen such that they are aligned with each other;
whereby one or more persons can view various multimedia and the operations of the operator on an opposite side of the laptop computer; or in the alternative, use the laptop as a presentation device.

2. The Dual Display Laptop Computer with Logic for display modes of claim 1 wherein the Base comprises a First video output for the purpose of transmitting signals between the motherboard and the anterior display screen, a Second video output for the purpose of transmitting signals between the motherboard and the posterior display screen, and a Motherboard for the purpose of transmitting signals and multimedia content through the video outputs to the dual display assembly;
the Dual display assembly comprises a Anterior display screen, a Posterior Display Screen, and a Display Frame.

3. The Dual Display Laptop Computer with Logic for display modes of claim 1 wherein the program logic enables the anterior display screen to operate in a locked mode.

4. The Dual Display Laptop Computer with Logic for display modes of claim 1 wherein the program logic enables the anterior display screen to operate in a fluid mode.

5. The Dual Display Laptop Computer with Logic for display modes of claim 1 wherein the anterior display screen is a touch screen.

6. The Dual Display Laptop Computer with Logic for display modes of claim 1 wherein the program logic enables the anterior display screen to operate in a touch screen mode.

7. The Dual Display Laptop Computer with Logic for display modes of claim 1, wherein the program logic enables the anterior display screen to minimize the amount of energy to be used, and to be turned off when not in use.

8. A Dual Display Laptop Computer with Logic for display modes comprising:
a. a Base, the Base having a rectangular shape;
b. a Dual display assembly; and
c. a Program Logic.

9. A Dual Display Laptop Computer with Logic for display modes comprising:
a Base having a rectangular shape for the purpose of housing the Program Logic and controlling the dual display assembly, a Dual display assembly for the purpose of displaying multimedia content one two separate screens opposing each other to enable two or more persons to view the multimedia from opposite sides of the laptop computer, a Program Logic for the purpose of sending a first transmission signal to the posterior display screen and sending a second transmission signal to the anterior display screen;
the Base in communication with the dual display assembly;
the Dual display assembly in communication with the motherboard through the first video output and the second video output;
the Program Logic in communication between the motherboard and the posterior display screen and the anterior display screen;
the Base comprises a First video output for the purpose of transmitting signals between the motherboard and the anterior display screen, a Second video output for the purpose of transmitting signals between the motherboard and the posterior display screen, and a Motherboard for the purpose of transmitting signals and multimedia content through the video outputs to the dual display assembly;
the Dual display assembly comprises a Anterior display screen.
